(19) United States
(12) Patent Application Publication
(10) Pub. No.: US 2020/0234389 A1
(43) Pub. Date: Jul. 23, 2020

(54) NOTIFICATION APPARATUS, TERMINAL, NOTIFICATION SYSTEM, NOTIFICATION METHOD, AND STORAGE MEDIUM

(71) Applicant: NEC CORPORATION, Tokyo (JP)

(72) Inventors: Katsuya NAKASHIMA, Tokyo (JP); Akihiro IWANAMI, Tokyo (JP); Koui NORIMATSU, Tokyo (JP); Yusuke ASHIDA, Tokyo (JP)

(73) Assignee: NEC CORPORATION, Tokyo (JP)

(21) Appl. No.: 16/652,603

(22) PCT Filed: May 20, 2019
(86) PCT No.: PCT/JP2019/019941

§ 371 Date: Mar. 31, 2020

(30) Foreign Application Priority Data
May 22, 2018 (JP) 2018-097937

(51) Int. Cl. G06Q 50/26; G06Q 50/30; G06Q 40/00; G07C 9/00

(52) U.S. Cl. CPC G06Q 50/265; G06Q 50/30; H04W 88/02; G07C 9/00896; G06Q 40/123

(57) ABSTRACT

Provided are a notification apparatus, a terminal, a notification system, a notification method, and a storage medium that can smoothly notify that a passenger is a targeted user of an automated gate. The notification apparatus includes: a determination unit that determines whether or not a passenger is a targeted user of an automated gate; and a notification unit that transmits, to a mobile terminal carried by the passenger, a notification indicating whether or not the passenger is a targeted user of the automated gate.

### TECHNICAL FIELD

The present invention relates to a notification apparatus, a terminal, a notification system, a notification method, and a storage medium.

### BACKGROUND ART

Patent Literature 1 discloses an entry immigration inspection system configured such that an external institute data affiliated server, a common control device, and a KIOSK terminal are connected to each other by a wide area network. In the entry immigration inspection system disclosed in Patent Literature 1, an automated-gate availability determination process is performed at the KIOSK terminal after arrival of a passenger, and a determination result is displayed on a screen of the KIOSK terminal.

### CITATION LIST

### Patent Literature

PTL 1: Japanese Patent Application Laid-open No. 2015-222459

### SUMMARY OF INVENTION

### Technical Problem

In the entry immigration inspection system disclosed in Patent Literature 1, however, passengers may wait in a line for the KIOSK terminal in the automated-gate availability determination process. Thus, it is difficult for the entry immigration inspection system disclosed in Patent Literature 1 to smoothly notify that a passenger is a targeted user of the automated gate.

In view of the problem described above, the present invention intends to provide a notification apparatus, a terminal, a notification system, a notification method, and a storage medium that can smoothly notify that a passenger is a targeted user of an automated gate.

### Solution to Problem

According to one example aspect of the present invention, provided is a notification apparatus including: a determination unit that determines whether or not a passenger is a targeted user of an automated gate; and a notification unit that transmits, to a mobile terminal carried by the passenger, a notification indicating whether or not the passenger is a targeted user of the automated gate.

According to another example aspect of the present invention, provided is a notification apparatus including: a determination unit that determines whether or not a passenger is a targeted user of an automated gate; and a notification unit that transmits, to a check-in terminal at which the passenger carries out a boarding procedure, a notification indicating whether or not the passenger is a targeted user of the automated gate.

According to yet another example aspect of the present invention, provided is a notification apparatus including: a determination unit that determines whether or not a passenger is a targeted user of an automated gate; and a notification unit that transmits, to a digital signage terminal, a notification indicating whether or not the passenger is a targeted user of the automated gate.

According to yet another example aspect of the present invention, provided is a terminal configured to communicate with a notification apparatus. The notification apparatus includes a determination unit that determines whether or not a passenger is a targeted user of an automated gate and a notification unit that transmits, to the terminal, a notification indicating whether or not the passenger is a targeted user of the automated gate. The terminal is a mobile terminal carried by the passenger and includes a receiving unit that receives the notification and a display unit that displays the notification.

According to yet another example aspect of the present invention, provided is a notification system including a notification apparatus and a terminal configured to communicate with the notification apparatus. The notification apparatus includes a determination unit that determines whether or not a passenger is a targeted user of an automated gate and a notification unit that transmits, to the terminal, a notification indicating whether or not the passenger is a targeted user of the automated gate. The terminal is a mobile terminal carried by the passenger and includes a receiving unit that receives the notification and a display unit that displays the notification.

According to yet another example aspect of the present invention, provided is a notification method including: determining whether or not a passenger is a targeted user of an automated gate; and transmitting, to a mobile terminal carried by the passenger, a notification indicating whether or not the passenger is a targeted user of the automated gate.

According to yet another example aspect of the present invention, provided is a storage medium storing a program that causes a computer to perform: determining whether or not a passenger is a targeted user of an automated gate; and transmitting, to a mobile terminal carried by the passenger, a notification indicating whether or not the passenger is a targeted user of the automated gate.

### Advantageous Effects of Invention

The present invention can smoothly notify that a passenger is a targeted user of an automated gate.

### BRIEF DESCRIPTION OF DRAWINGS

FIG. 1 is a schematic diagram illustrating an overall configuration of a notification system according to a first example embodiment of the present invention.

FIG. 2 is a schematic diagram illustrating an inspection site in which an automated gate and an inspection booth are installed.

FIG. 3 is a block diagram illustrating one example of a hardware configuration of a management server, a notification server, and the automated gate in the notification system according to the first example embodiment of the present invention.

FIG. 4 is a block diagram illustrating one example of a hardware configuration of a mobile terminal in the notification system according to the first example embodiment of the present invention.

FIG. 5 is a sequence diagram illustrating the operation of the management server, the notification server, and the mobile terminal in the notification system according to the first example embodiment of the present invention.

FIG. 6 is a schematic diagram illustrating one example of an entry screen of ED card information at the mobile terminal according to the first example embodiment of the present invention.

FIG. 7 is a schematic diagram illustrating one example of an entry screen of passport information at the mobile terminal according to the first example embodiment of the present invention.

FIG. 8 is a schematic diagram illustrating one example of a screen at mobile payment on the mobile terminal according to the first example embodiment of the present invention.

FIG. 9 is a schematic diagram illustrating one example of a notification screen on the mobile terminal that notifies that a passenger is a targeted user of the automated gate according to the first example embodiment of the present invention.

FIG. 10 is a schematic diagram illustrating one example of a notification screen on the mobile terminal that notifies that a passenger is not a targeted user of the automated gate according to the first example embodiment of the present invention.

FIG. 11 is a sequence diagram illustrating the operation of a management server, a notification server, and a check-in terminal in a notification system according to a second example embodiment of the present invention.

FIG. 12 is a block diagram illustrating a configuration of a notification system according to another example embodiment of the present invention.

### DESCRIPTION OF EMBODIMENTS

### First Example Embodiment

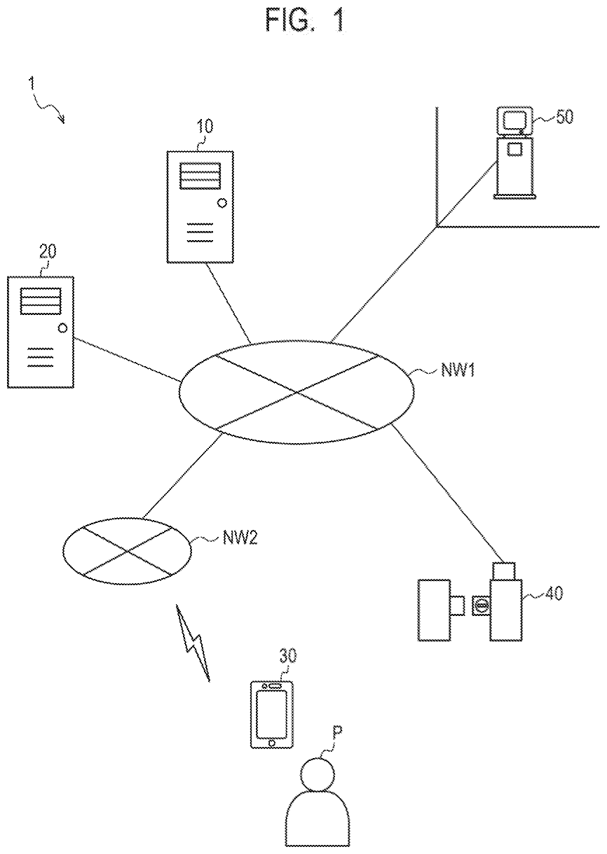

A notification apparatus, a terminal, a notification system, and a notification method according to a first example embodiment of the present invention will be described with reference to FIG. 1 to FIG. 10.

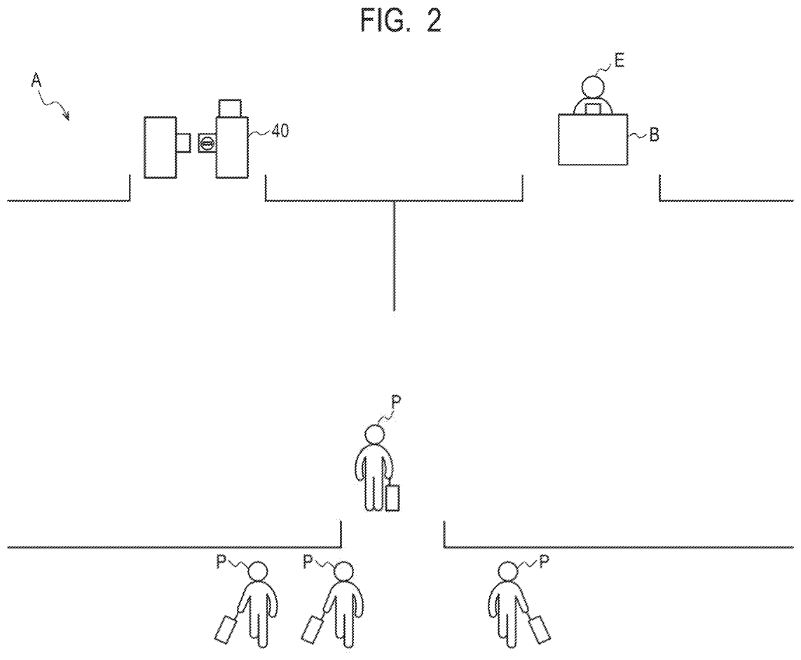

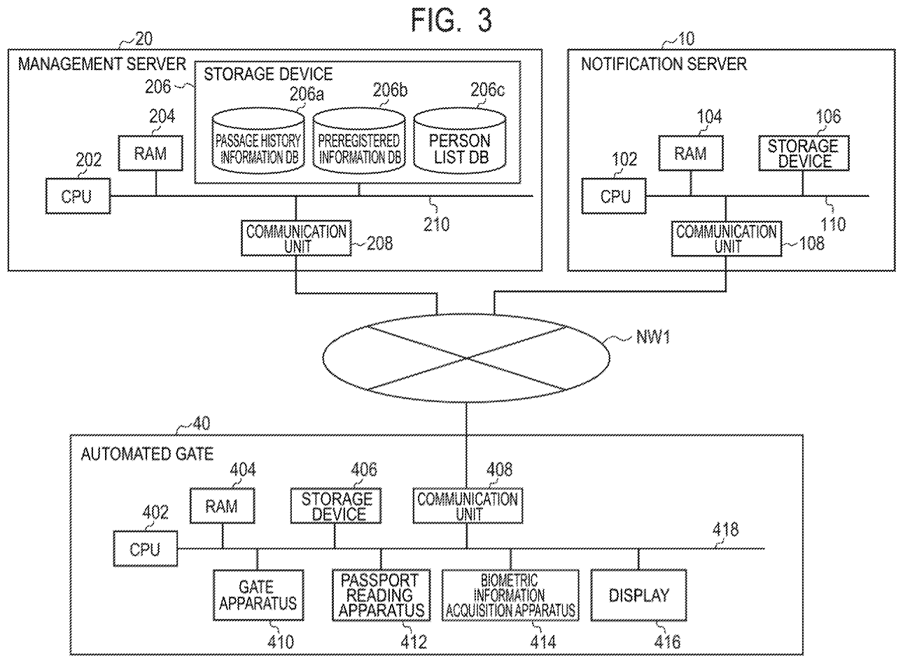

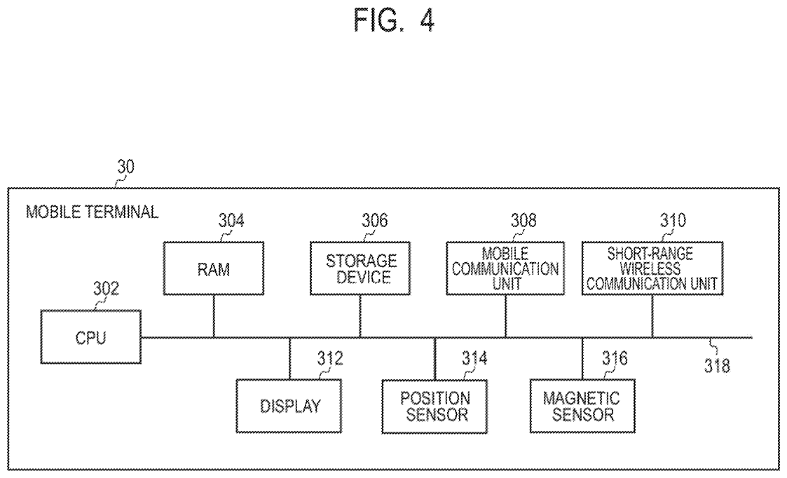

First, the configuration of the notification system according to the present example embodiment will be described with reference to FIG. 1 to FIG. 4. FIG. 1 is a schematic diagram illustrating an overall configuration of a notification system according to the present example embodiment. FIG. 2 is a schematic diagram illustrating an inspection site in which an automated gate and an inspection booth are installed. FIG. 3 is a block diagram illustrating one example of a hardware configuration of a notification server, a management server, and the automated gate in the notification system according to the present example embodiment. FIG. 4 is a block diagram illustrating a hardware configuration of a mobile terminal in the notification system according to the present example embodiment.

As illustrated in FIG. 1, a notification system 1 according to the present example embodiment includes a notification server 10, a management server 20, a mobile terminal 30, an automated gate 40, and a check-in terminal 50. The notification system 1 according to the present example embodiment notifies a passenger P subjected to departure inspection or entry inspection whether or not he/she is a targeted user of the automated gate 40 that performs automatic procedure of departure inspection or entry inspection at an airport of a country in which the notification system 1 is operated, for example. In the following description, a country in which the notification system 1 is operated is simply referred to as “the country of interest” as appropriate necessary. Further, departure from a country or entry to a country is simply referred to as “immigration” as appropriate. Further, departure inspection or entry inspection is simply referred to as “immigration inspection” as appropriate.

Note that the notification system 1 may notify whether or not a passenger is a targeted user of the automated gate 40 installed in a facility in which immigration inspection is performed, such as a seaport, a border of the country of interest checkpoint in addition to an airport of the country of interest.

The notification server 10 and the management server 20 are installed inside a facility of an admission office of the country of interest that manages immigration, for example. The mobile terminal 30 is a terminal held or carried and used by the passenger P. The automated gate 40 is installed at an inspection site in which immigration inspection is performed at an airport, for example. As illustrated in FIG. 2, the automated gate 40 is installed in an inspection site A in which immigration inspection is performed. Further, an inspection booth B in which face-to-face inspection is performed by an examiner E is installed in the inspection site A.

Note that the automated gate 40 that automatically performs procedure of entry inspection is installed in an entry inspection site in which entry inspection is performed. The automated gate 40 that automatically performs procedure of departure inspection is installed in a departure inspection site, which is separate from the entry inspection site, in which departure inspection is performed. Further, the number of automated gates 40 installed in the inspection site A is not particularly limited and may be one or plural.

The check-in terminal 50 is a terminal at which the passenger P who makes a passage from a foreign country to the country of interest performs a boarding procedure of an airplane bound for the country of interest at an airport of the foreign country. Note that the check-in terminal 50 may be a terminal at which the passenger P who makes a passage from a foreign country to the country of interest performs a boarding procedure of a vehicle such as a ship other than an airplane bound for the country of interest. The check-in terminal 50 will be described in a second example embodiment. For example, when the passenger P who lives in the United States departs from the United States to make a passage to Japan, the foreign country described above is the United States, and the country of interest is Japan.

The notification server 10, the management server 20, the automated gate 40, and the check-in terminal 50 are connected to a network NW1. The network NW1 is formed of a wide area network (WAN), a local area network (LAN), or the like. A mobile communication network NW2 is connected to the network NW1. The mobile terminal 30 can be connected to the network NW1 via the mobile communication network NW2.

The notification server 10 and the management server 20 can communicate with each other via the network NW1. The notification server 10 and the mobile terminal 30 can communicate with each other via the network NW1 and the mobile communication network NW2. The notification server 10 and the check-in terminal 50 can communicate with each other via the network NW1. The management server 20 and the automated gate 40 can communicate with each other via the network NW1.

The notification server 10 functions as a notification apparatus that transmits, to the mobile terminal 30 of the passenger P, a notification indicating whether or not the passenger P carrying the mobile terminal 30 is a targeted user of the automated gate 40. As illustrated in FIG. 3, the notification server 10 has a central processing unit (CPU) 102, a random access memory (RAM) 104, a storage device 106, and a communication unit 108. The CPU 102, the RAM 104, the storage device 106, and the communication unit 108 are connected to a bus line 110.

The CPU 102 functions as a control unit that operates by executing a program stored in the storage device 106 and controls the operation of the overall notification server 10. Further, the CPU 102 executes an application program stored in the storage device 106 and performs various processes as the notification apparatus. The RAM 104 provides a memory area required for the operation of the CPU 102.

More specifically, the CPU 102 functions as a determination unit and determines whether or not the passenger P carrying the mobile terminal 30 is a targeted user of the automated gate 40 in accordance with a determination request transmitted from the mobile terminal 30. For this determination, the CPU 102 that functions as a determination unit acquires passage history information or preregistered information on the passenger P from the management server 20 via the network NW1. The CPU 102 determines whether or not the passenger P carrying the mobile terminal 30 is a targeted user of the automated gate 40 based on the acquired passage history information or preregistered information.

Further, the CPU 102 functions as a notification unit and generates a notification indicating the above determination result as to whether or not the passenger P carrying the mobile terminal 30 is a targeted user of the automated gate 40. Furthermore, the CPU 102 transmits the generated notification to the mobile terminal 30 of the passenger P via the network NW1.

The storage device 106 is formed of a storage medium such as a nonvolatile memory, a hard disk drive, or the like and functions as a storage unit. The storage device 106 stores a program executed by the CPU 102, data referenced by the CPU 102 when executing the program, or the like.

The communication unit 108 is connected to the network NW1 and transmits and receives data via the network NW1. The communication unit 108 communicates with the management server 20, the mobile terminal 30, the check-in terminal 50, or the like under the control of the CPU 102.

The notification server 10 is configured in such a way.

The management server 20 functions as a management apparatus that stores and manages various information required for immigration inspection operation of the country of interest. As illustrated in FIG. 3, the management server 20 has a CPU 202, a RAM 204, a storage device 206, and a communication unit 208. The CPU 202, the RAM 204, the storage device 206, and the communication unit 208 are connected to a bus line 210.

The CPU 202 functions as a control unit that operates by executing a program stored in the storage device 206 and controls the operation of the overall management server 20. Further, the CPU 202 executes an application program stored in the storage device 206 and performs various processes as the management apparatus. The RAM 204 provides a memory area required for the operation of the CPU 202.

More specifically, the CPU 202 functions as a management unit and records and manages passage history information regarding immigration of the passenger P in the country of interest in the storage device 206. In the country of interest, foreigners enter the country from various foreign countries for various purposes such as tourism, business, or the like, and the foreigners who have entered the country then depart from the country. Further, in the country of interest, citizens of the country and foreign residents depart from the country for various purposes such as tourism, business, temporary homecoming, or the like, and the citizens of the country and the foreign residents who have departed from the country then enter the country. Such various passage history information on the passenger P is acquired by the face-to-face inspection booth B in the inspection site A, the automated gate 40, or the like and transmitted to the management server 20, for example. The CPU 202 stores and manages the transmitted passage history information in the storage device 206. Note that a foreigner means a person who does not have nationality of the country of interest.

Further, the CPU 202 functions as a management unit and stores and manages, in the storage device 206, preregistered information regarding the passenger P on which user registration of the automated gate 40 has been performed. The CPU 202 registers and manages preregistered information in a preregistered information DB 206b stored in the storage device 206. For example, the passenger P who wishes to use the automated gate 40 is examined in accordance with a pre-application and, when user registration is performed, is allowed to use the automated gate 40. Further, for example, the automated gate 40 is also available for the passenger P for which user registration is finished under the admission of the home country of the passenger P based on a bilateral agreement between the home country of the passenger P and the country of interest. Further, in addition to the above, the automated gate 40 is available for the passenger P for which user registration is finished in accordance with a trusted traveler program (TTP), a predetermined residence qualification, a reentry permission, a paid application, or the like, for example. The CPU 202 stores and manages, in the storage device 206, preregistration information that is information regarding the passenger P preregistered as a person who is allowed to use the automated gate 40.

The CPU 202 transmits passage history information or preregistered information on the passenger P to the notification server 10 in accordance with a request transmitted from the notification server 10.

Further, the CPU 202 functions as a management unit and stores and manages, in the storage device 206, a person list including a watch list and a trusted list. The CPU 202 registers and manages a person list in a person list DB 206c stored in the storage device 206. The watch list is a list that registers person information including biometric information on a person under surveillance who requires special attention in immigration inspection or who is to be rejected before immigration. The trusted list is a list that registers person information including biometric information on a person who is to be permitted for entry to the site. A person list is used for matching at the automated gate 40 or matching at the inspection booth B, for example. Note that the person list is not necessarily required to include both the watch list and the trusted list but may include either one of the watch list and the trusted list.

The storage device 206 is formed of a storage medium such as a nonvolatile memory, a hard disk drive, or the like and functions as a storage unit. The storage device 206 stores a program executed by the CPU 202, data referenced by the CPU 202 when executing the program, or the like.

Further, the storage device 206 stores a passage history information database (DB) 206a that is a first database, a preregistered information DB 206b that is a second database, and a person list DB 206c that is a third database. The passage history information described above is registered in the passage history information DB 206a. The preregistered information described above is registered in the preregistered information DB 206b. The person list described above is registered in the person list DB 206c.

The passage history information registered in the passage history information DB 206a is information regarding the passenger P having a passage history of entry to the country of interest. For example, the passage history information is registered when the passenger P enters the country of interest and when the passenger P departs from the country of interest. For example, the passage history information includes passport information, biometric information, history information, or the like on the passenger P having a passage history to the country of interest. The passport information includes a passport number, a passport issuance country, identity information, or the like of a passport issued for the passenger P. The identity information includes the name, the nationality, the date of birth, the sexuality, or the like of the passenger P. The biometric information is a fingerprint image, a face image, an iris image, a finger vein image, a palm-print image, a palm vein image, or the like of the passenger P. One or multiple pieces of biometric information may be used. Further, the biometric information may be acquired from integrated circuit (IC) passport in which biometric information on the passenger P is stored or may be acquired directly from the passenger P in inspection. The history information includes an entry country, a date of entry, a departure country, a date of departure, a flight number, or the like on the passenger P. The entry country and the departure country may mean an airport for entry to the country and an airport for departure from the country, respectively. The passage history information and the passport information, biometric information, and history information included in the passage history information are associated with each other.

The preregistered information registered in the preregistered information DB 206b is information regarding the passenger P preregistered as a person who is allowed to use the automated gate 40. For example, the preregistered information includes passport information, biometric information, or the like on the passenger P preregistered as a person who is allowed to use the automated gate 40 in accordance with a pre-application, a bilateral agreement, a TTP, a predetermined residence qualification, a reentry permission, a paid application, or the like. The passport information includes a passport number, a passport issuance country, identity information, or the like of a passport issued for the passenger P. The identity information includes the name, the nationality, the date of birth, the sexuality, or the like of the passenger P. The biometric information is a fingerprint image, a face image, an iris image, a finger vein image, a palm-print image, a palm vein image, or the like of the passenger P. One or multiple pieces of biometric information may be used. Further, the biometric information is provided from the passenger P in preregistration. The preregistered information and the passport information and biometric information included in the preregistered information are associated with each other.

The person list registered in the person list DB 206c includes a watch list and a trusted list. In the watch list, biometric information, text information, or the like is registered as person information on a person under surveillance who requires special attention in immigration inspection or who is to be rejected before immigration. Further, in the trusted list, biometric information, text information, or the like is registered as person information on a person who is to be permitted for entry to the site. The biometric information included in each person information of the watch list and the trusted list may be, for example, a fingerprint image, a face image, an iris image, a finger vein image, a palm-print image, a palm vein image, or the like of the person of interest.

The communication unit 208 is connected to the network NW1 and transmits and receives data via the network NW1. The communication unit 208 communicates with the notification server 10 or the like under the control of the CPU 202.

The management server 20 is configured in such a way.

The automated gate 40 functions as an automatic procedure apparatus that automatically performs a procedure of immigration inspection of the passenger P who is a targeted user of the automated gate 40 who is allowed to use the automated gate 40. The automated gate 40 functions as a matching device that performs matching of biometric information.

As illustrated in FIG. 3, the automated gate 40 includes a CPU 402, a RAM 404, a storage device 406, a communication unit 408, a gate apparatus 410, a passport reading apparatus 412, a biometric information acquisition apparatus 414, and a display 416. The CPU 402, the RAM 404, the storage device 406, the communication unit 408, the gate apparatus 410, the passport reading apparatus 412, the biometric information acquisition apparatus 414, and the display 416 are connected to a bus line 418.

The CPU 402 functions as a control unit that operates by executing a program stored in the storage device 406 and controls the operation of the overall automated gate 40. Further, the CPU 402 executes an application program stored in the storage device 406 and performs various processes as the automatic procedure apparatus. The RAM 404 provides a memory area required for the operation of the CPU 402.

The storage device 406 is formed of a storage medium such as a nonvolatile memory, a hard disk drive, or the like and functions as a storage unit. The storage device 406 stores a program executed by the CPU 402, data referenced by the CPU 402 when executing the program, or the like.

The communication unit 408 is connected to the network NW1 and transmits and receives data via the network NW1. The communication unit 408 communicates with the management server 20 or the like under the control of the CPU 402.

The gate apparatus 410 transitions from a closed state for standby to block passage of the passenger P to an opened state to permit passage of the passenger P after the passenger P passed through immigration inspection at the automated gate 40. The scheme of the gate apparatus 410 is not particularly limited and may be, for example, a flapper gate whose flapper provided on one side of the pathway or flappers provided on both sides of the pathway are opened and closed, a turn style gate whose three bars rotate, or the like.

The passport reading apparatus 412 functions as a passport information acquisition unit that reads a passport of the passenger P and acquires information recorded on the passport in immigration inspection at the automated gate 40. The passport reading apparatus 412 is formed of an optical character reader (OCR) apparatus or a contactless integrated circuit (IC) reader, for example. The passport reading apparatus 412 reads a passport number written on a passport sheet by using an OCR apparatus. Further, in a case of an IC passport, the passport reading apparatus 412 reads a passport number stored in an IC chip of the IC passport by using a contactless IC reader.

Further, in a case of an IC passport, biometric information such as a fingerprint image, a face image, an iris image, a finger vein image, a palm-print image, a palm vein image, or the like of the passenger P at passport application is stored and preregistered in the IC chip thereof. One or multiple pieces of biometric information may be preregistered in an IC chip. Further, multiple pieces of biometric information may be any combination of biometric information. When biometric information is stored in an IC chip, the passport reading apparatus 412 further reads and acquires biometric information stored in an IC chip. The biometric information acquired from an IC passport by the passport reading apparatus 412 is matched with the same type of biometric information acquired by the biometric information acquisition apparatus 414 and used for identity verification of the passenger P.

The biometric information acquisition apparatus 414 functions as a biometric information acquisition unit that acquires biometric information on the passenger P who is a targeted user to perform a procedure at the automated gate 40. For example, the biometric information acquisition apparatus 414 acquires biometric information such as a fingerprint image, a face image, an iris image, a finger vein image, a palm-print image, a palm vein image, or the like of the passenger P. One or multiple pieces of biometric information may be acquired by the biometric information acquisition apparatus 414. Further, multiple pieces of biometric information may be any combination of biometric information.

The display 416 is formed of a touch panel display, for example. The display 416 functions as a display unit and an input unit that displays operation guidance to the passenger P who performs a procedure at the automated gate 40 and accepts entry of an operation instruction from the passenger P.

The automated gate 40 determines, out of passengers P, a particular passenger P as a targeted user as described below who enters the country of interest or who departs from the country of interest and automatically performs an immigration inspection procedure of the particular passenger P. In an immigration inspection procedure, the CPU 402 of the automated gate 40 functions as a matching unit that matches biometric information.

For example, the automated gate 40 automatically performs an immigration inspection procedure of the passenger P, where the number of times of passages to the country of interest made by the passenger P within a predetermined period immediately before the entry to the country of interest is greater than or equal to a predetermined number of times. The passage frequency of the passenger P who is a targeted user of the automated gate 40 is not particularly limited, which may be, for example, a frequency that the number of times of passages within one year immediately before the entry to the country is five times or more, the number of times of passages within one month or two months immediately before the entry to the country is one or more, or the like. In such a case, for identity verification, the CPU 402 that functions as a matching unit matches, at 1:1, biometric information on the passenger P acquired by the biometric information acquisition apparatus 414 with the same type of biometric information acquired from an IC passport of the passenger P by the passport reading apparatus 412. Further, for identity verification, the CPU 402 may also match, at 1:N, biometric information on the passenger P acquired by the biometric information acquisition apparatus 414 with the same type of biometric information included in the passage history information on a plurality of persons registered in the passage history information DB 206a of the management server 20. In such 1:N matching, the CPU 402 matches biometric information on the passenger P acquired by the biometric information acquisition apparatus 414 with the passage history information on a plurality of persons registered in the passage history information DB 206a without using the passport reading apparatus 412.

Further, for example, the automated gate 40 automatically performs an immigration inspection procedure of the passenger P preregistered in the preregistered information of the management server 20 as a person who is allowed to use the automated gate 40. In such a case, for identity verification, the CPU 402 that functions as a matching unit matches biometric information on the passenger P acquired by the biometric information acquisition apparatus 414 with the same type of biometric information on the passenger P included in the preregistered information stored in the management server 20.

Further, the CPU 402 that functions as a matching unit may match, at 1:N, biometric information on the passenger P acquired by the biometric information acquisition apparatus 414 with the same type of biometric information on a plurality of persons included in the watch list or the trusted list registered in the person list DB 206c of the management server 20. Accordingly, the CPU 402 can perform watch list matching or trusted list matching with respect to the passenger P.

The automated gate 40 is configured in such a way.

The mobile terminal 30 is a terminal held or carried and used by the passenger P, which may be, for example, a mobile information device such as a smartphone, a tablet terminal, a mobile phone, or the like. As illustrated in FIG. 4, the mobile terminal 30 includes a CPU 302, a RAM 304, a storage device 306, a mobile communication unit 308, a short-range wireless communication unit 310, a display 312, a position sensor 314, and a magnetic sensor 316. The CPU 302, the RAM 304, the storage device 306, the mobile communication unit 308, the short-range wireless communication unit 310, the display 312, the position sensor 314, and the magnetic sensor 316 are connected to a bus line 318.

The CPU 302 functions as a control unit that operates by executing a program stored in the storage device 306 and controls the operation of the mobile terminal 30. Further, the CPU 302 executes an application program stored in the storage device 306 and performs various processes as a mobile information device. The RAM 304 provides a memory area required for the operation of the CPU 302.

For example, a support application that supports an immigration procedure and a procedure associated therewith performed by the passenger P in the country of interest is installed in the storage device 306. The number of countries of interest where the support application supports an immigration procedure may be one or plural. When the number of counties of interest is one, the country of interest is a destination country, and a notification as to whether or not the passenger P is a targeted user of the automated gate 40 in the country of interest is performed. When the number of countries of interest is plural, the passenger P is able to set the country of interest to be a destination country out of the plurality of countries on the support application. Thereby, a destination country is set as the country of interest out of the plurality of countries of interest, and with respect to the country of interest, a notification as to whether or not the passenger P is a targeted user of the automated gate 40 is to be performed. The CPU 302 executes the support application and thereby can perform a process regarding an immigration procedure and a procedure associated therewith performed by the passenger P in the country of interest. Specifically, the CPU 302 may perform preregistration of embarkation/disembarkation card (ED card) information, digitized storage of passport information, mobile payment of airport taxes required to be paid locally, or the like, for example, as described later. The airport taxes may be, for example, a departure tax, an entry tax, an airport fee, a security service fee, or the like. Further, the CPU 302 can also acquire information on the destination country of interest from procedure information at mobile check-in performed by the mobile terminal 30, ED card information, information on a country to which airport taxes are paid, or the like, for example. Specifically, the information on the destination country of interest may be a passage history of the passenger P in the destination country of interest, preregistered information, or the like.

Further, the CPU 302 functions as a request unit and requests determination from the notification server 10 as to whether or not the passenger P carrying the mobile terminal 30 is a targeted user of the automated gate 40. The CPU 302 that functions as the request unit transmits a determination request to the notification server 10 via the mobile communication network NW2 and the network NW1.

Further, the CPU 302 functions as a receiving unit and receives a notification indicating whether or not the passenger P carrying the mobile terminal 30 is a targeted user of the automated gate 40 from the notification server 10 via the network NW1 and the mobile communication network NW2.

The storage device 306 is formed of a storage medium such as a nonvolatile memory, a hard disk drive, or the like and functions as a storage unit. The storage device 306 stores a program executed by the CPU 302, data referenced by the CPU 302 when executing the program, or the like. For example, the storage device 306 stores the support application described above.

The mobile communication unit 308 establishes a connection to the mobile communication network NW2 to perform wireless communication under the control of the CPU 302. The mobile communication unit 308 establishes a connection to the network NW1 via the mobile communication network NW2. The communication scheme of the mobile communication unit 308 is not particularly limited and may be, for example, a third generation mobile communication scheme, Long Term Evolution (LTE) scheme, a fourth generation mobile communication scheme, or the like.

The short-range wireless communication unit 310 wirelessly communicates with an access point, an external device, or the like under the control of the CPU 302. The communication scheme of the short-range wireless communication unit 310 is not particularly limited and may be, for example, a wireless LAN scheme such as Wi-Fi (registered trademark), a Bluetooth (registered trademark) communication scheme, a Near Field Communication (NFC) scheme, an infrared communication scheme, or the like.

The display 312 is a touch panel display that functions as a display unit having a display screen and functions as an input unit that accepts touch entry on the display screen. The display 312 displays a screen of an application program started up at the mobile terminal 30 and displays various information to the passenger P. The passenger P is able to operate an application program by touch entry on the display screen of the display 312.

The position sensor 314 measures the position of the mobile terminal 30 by using Global Navigation Satellite System (GNSS). Thereby, the position sensor 314 acquires position information indicating the position of the mobile terminal 30. The GNSS is not particularly limited and may be, for example, Global Positioning System (GPS), Global Navigation Satellite System (GLONASS), Galileo, Compass, or the like.

The magnetic sensor 316 detects terrestrial magnetism at the position of the mobile terminal 30 and acquires terrestrial magnetism information. The magnetic sensor 316 is not particularly limited and detects terrestrial magnetism by using a hall element, a magnetic resistor element, a magnetic impedance element, or the like, for example.

The mobile terminal 30 is configured in such a way.

Since the automated gate 40 automatically performs immigration inspection of the passenger P who is a targeted user thereof, it is possible to perform an immigration procedure smoothly and quickly even when the immigration inspection site is congested. On the other hand, the passenger P who satisfies a particular requirement may be a targeted user of the automated gate 40 without preregistration, where the particular requirement may be a requirement for the number of times of passages within a predetermined period, such as five or greater within a year, one or greater within one month or two months. In such a case, the passenger P may be unable to recognize whether or not he/she is a targeted user of the automated gate 40. Therefore, in such a case, for the passenger P who is determined as a targeted user of the automated gate 40, there may be a great need to notify that he/she is a targeted user of the automated gate 40.

Further, even for the passenger P preregistered as a user of the automated gate 40, it is preferable to notify before immigration inspection that he/she is a targeted user of the automated gate 40 in terms of preventing the passenger P from forgetting availability of the automated gate 40.

The notification system 1 according to the present example embodiment notifies the mobile terminal 30 of the passenger P who is to be subjected to immigration inspection at a particular notification timing whether or not he/she is a targeted user of the automated gate 40. The passenger P receives a notification at the mobile terminal 30 carried by himself/herself and thus can smoothly recognize whether or not he/she is a targeted user of the automated gate 40. The passenger P is no longer necessary to wait in a line at a dedicated terminal that notifies whether or not he/she is a targeted user of the automated gate 40 at an airport or the like. In such a way, the notification system 1 according to the present example embodiment can smoothly notify the passenger P whether or not he/she is a targeted user of the automated gate 40.

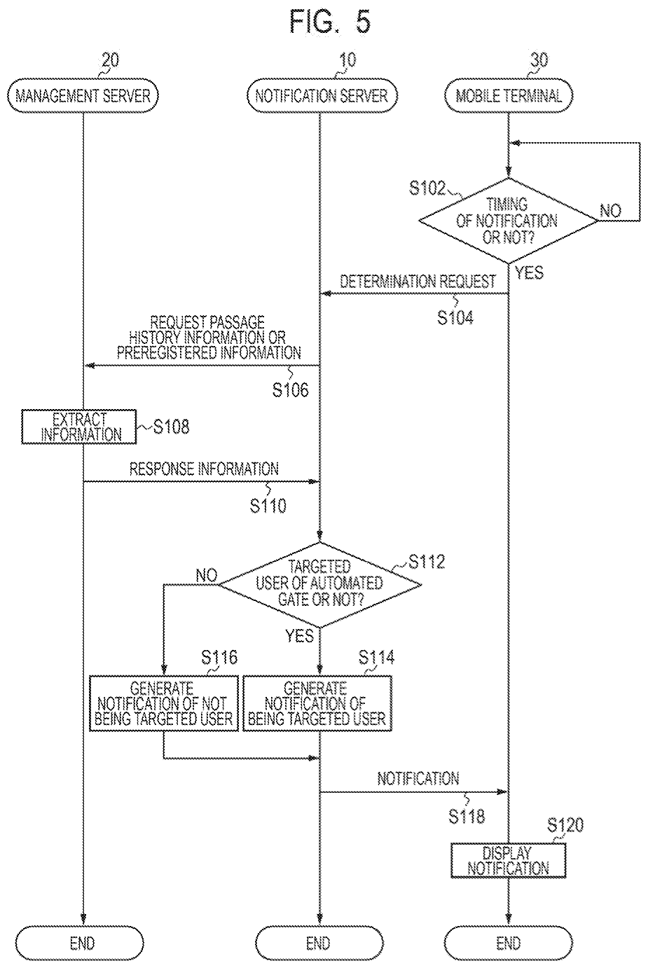

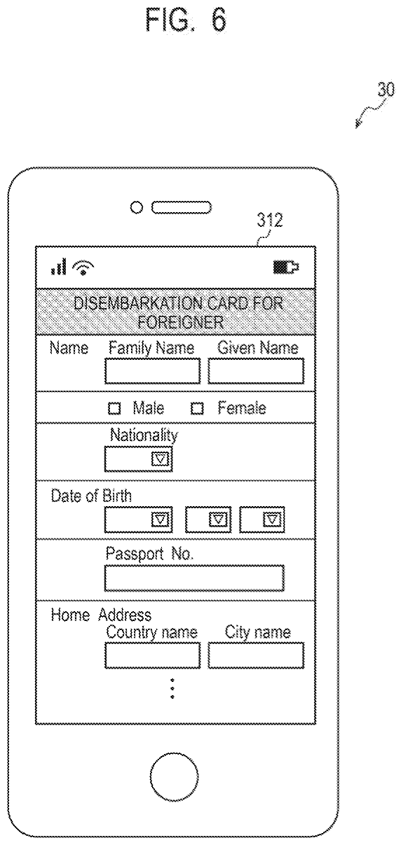

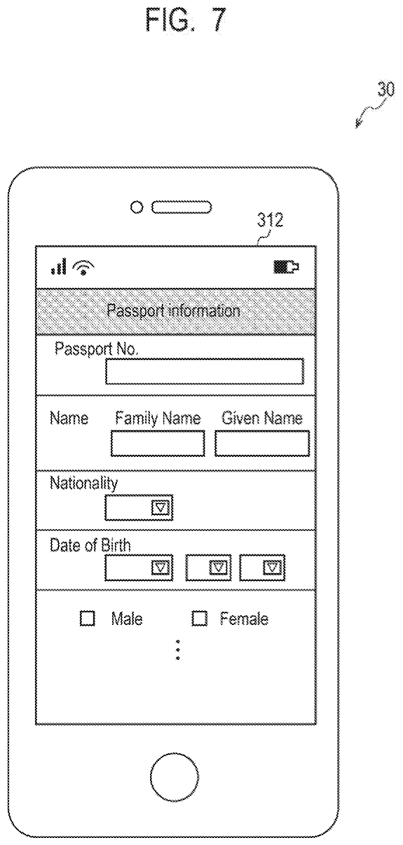

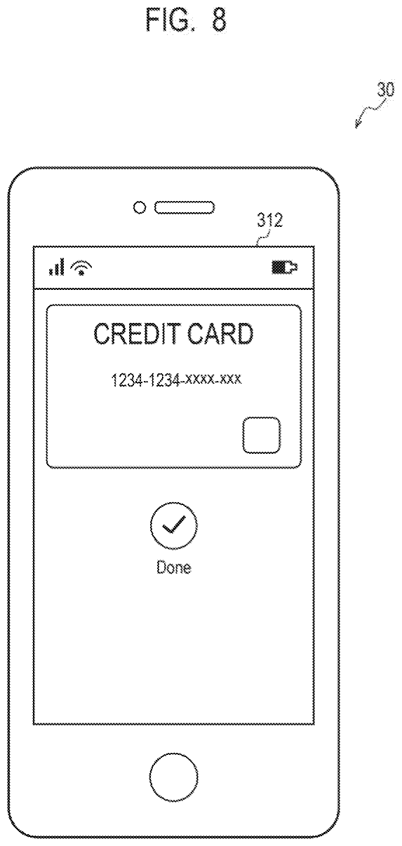

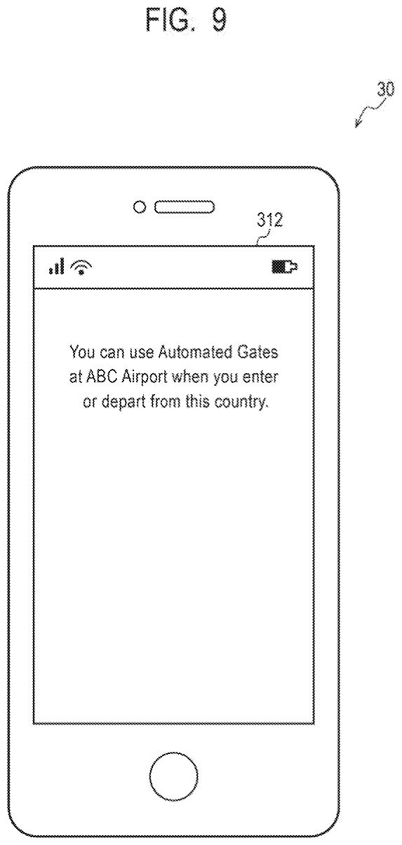

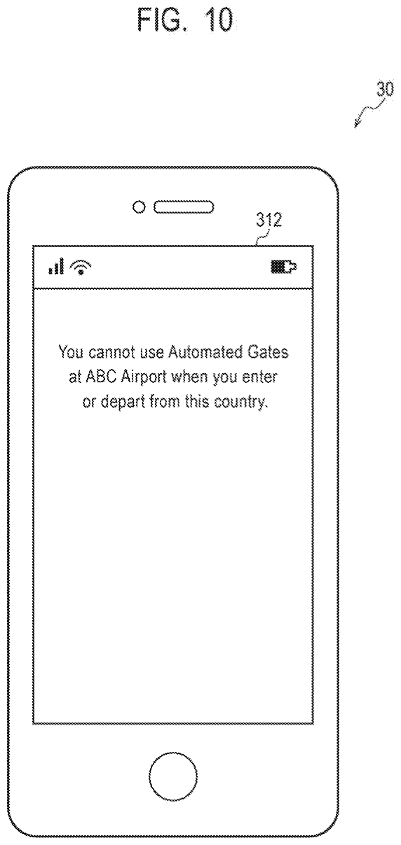

A notification operation in the notification system 1 according to the present example embodiment will be further described below with reference to FIG. 5 to FIG. 10. FIG. 5 is a sequence diagram illustrating the operation of the management server 20, the notification server 10, and the mobile terminal 30 in the notification system 1 according to the present example embodiment. FIG. 6 is a schematic diagram illustrating one example of an entry screen of ED card information at the mobile terminal 30 according to the present example embodiment. FIG. 7 is a schematic diagram illustrating one example of an entry screen of passport information at the mobile terminal 30 according to the present example embodiment. FIG. 8 is a schematic diagram illustrating one example of a screen at mobile payment on the mobile terminal 30 according to the present example embodiment. FIG. 9 is a schematic diagram illustrating one example of a notification screen on the mobile terminal 30 that notifies that a passenger is a targeted user of the automated gate 40 according to the present example embodiment. FIG. 10 is a schematic diagram illustrating one example of a notification screen on the mobile terminal 30 that notifies that a passenger is not a targeted user of the automated gate 40 according to the present example embodiment. When the notification operation in the notification system 1 according to the present example embodiment is performed, the notification method according to the present example embodiment is performed.

First, as illustrated in FIG. 5, the CPU 302 of the mobile terminal 30 determines whether or not it is a particular notification timing to notify whether or not the passenger P who is a user of the mobile terminal 30 thereof is a targeted user of the automated gate 40 (step S102). If it is not determined to be the particular notification timing (step S102, NO), the CPU 302 continuously determines whether or not it is the particular notification timing and stands by for arrival of the particular notification timing. Note that the CPU 302 can acquire, from information set in the support application in the mobile terminal 30, for example, information on the destination country of interest where it has to notify whether or not the passenger P is a targeted user of the automated gate 40. Further, the CPU 302 can also acquire information on the destination country of interest from procedure information at mobile check-in performed by the mobile terminal 30, ED card information, information on a country to which airport taxes are paid, or the like. Specifically, the information on the destination country of interest may be a passage history of the passenger P in the destination country of interest, preregistered information, or the like.

The particular notification timing to notify whether or not the passenger P is a targeted user of the automated gate 40 is not particularly limited and may be, for example, a timing when the mobile terminal 30 is operated by the passenger P in association with entry to the country of interest or departure from the country of interest. More specifically, the CPU 302 determines that it is a particular notification timing to notify whether or not the passenger P is a targeted user of the automated gate 40 at a timing below, for example.

For example, the mobile terminal 30 can preregister ED card information by executing the support application. The ED card information is information regarding items to be filled in an ED card, which may be, for example, the name, the sexuality, the nationality, the date of birth, the passport number, the address in the residence country, a contact address during stay, a stay period, a boarding location, an arrival flight number, or the like. For example, as illustrated in FIG. 6, the passenger P is able to operate the mobile terminal 30 to input ED card information by touch entry on the display 312 of the mobile terminal 30 that executes the support application.

The CPU 302 of the mobile terminal 30 transmits ED card information input by the passenger P to the management server 20 via the mobile communication network NW2 and the network NW1. The CPU 202 of the management server 20 stores the ED card information transmitted from the mobile terminal 30 in the storage device 206. In such a way, the ED card information is preregistered in the management server 20. The preregistered ED card information is provided for a use in immigration inspection via the network NW1, for example.

The CPU 302 of the mobile terminal 30 can determine the timing when the mobile terminal 30 is operated by the passenger P and the ED card information is input as described above as the particular notification timing to notify whether or not the passenger P is a targeted user of the automated gate 40.

Further, for example, the mobile terminal 30 can digitize and store passport information in the terminal by executing the support application. The passport information is information regarding items written on a passport sheet, which may be the passport number, the passport issuance country, the name, the nationality, the date of birth, the sexuality, the date of issuance, the expiry date, or the like. As illustrated in FIG. 7, for example, the passenger P may operate the mobile terminal 30 to input passport information by touch entry on the display 312 of the mobile terminal 30 that executes the support application.

The CPU 302 of the mobile terminal 30 stores the passport information input by the passenger P in the storage device 306. In such a way, passport information is digitized and stored in the mobile terminal 30. The CPU 302 can convert the digitized and stored passport information into a code symbol such as a QR code (registered trademark) and cause the display 312 to display the converted passport information. The passport information converted into a code symbol is read by a scanner and provided for a use in immigration inspection.

The CPU 302 of the mobile terminal 30 transmits the passport information input by the passenger P to the management server 20 via the mobile communication network NW2 and the network NW1. The CPU 202 of the management server 20 stores the passport information transmitted from the mobile terminal 30 in the storage device 206. In such a way, the passport information is preregistered in the management server 20. The preregistered passport information is provided for a use in immigration inspection via the network NW1, for example.

The CPU 302 of the mobile terminal 30 can determine that the timing when the mobile terminal 30 is operated by the passenger P and the passport information is input as described above is a particular notification timing to notify whether or not the passenger P is a targeted user of the automated gate 40.

Further, for example, the mobile terminal 30 can perform mobile payment of taxes required to be paid locally in association with entry to the country of interest or departure from the country of interest by executing the support application. The taxes required to be paid locally in association with entry to the country of interest or departure from the country of interest are airport taxes required to be paid locally, such as a departure tax, an entry tax, an airport fee, a security service fee, or the like, for example. As illustrated in FIG. 8, for example, the passenger P may operate the mobile terminal 30 to perform mobile payment by using a payment card set in the mobile terminal 30 that executes the support application. The payment card is not particularly limited and may be, for example, a credit card, a prepaid card, a debit card, or the like.

The CPU 302 of the mobile terminal 30 transmits the payment information in accordance with mobile payment of taxes performed by the passenger to the management server 20 via the mobile communication network NW2 and the network NW1. The CPU 202 of the management server 20 stores the payment information transmitted from the mobile terminal 30 in the storage device 206. In such a way, the payment information is preregistered in the management server 20. The preregistered payment information is provided for a use in immigration inspection via the network NW1, for example.

The CPU 302 of the mobile terminal 30 can determine that the timing when the mobile terminal 30 is operated by the passenger P and mobile payment of airport taxes is performed as described above is the particular notification timing to notify whether or not the passenger P is a targeted user of the automated gate 40.

Further, for example, the CPU 302 of the mobile terminal 30 can measure the position of the mobile terminal 30 based on position information acquired by the position sensor 314. Further, the CPU 302 can measure the position of the mobile terminal 30, in particular, a position of the mobile terminal 30 inside a building where it is difficult to receive a GNSS signal such as a GPS signal based on terrestrial magnetism information acquired by the magnetic sensor 316. The CPU 302 can determine that it is the particular notification timing to notify whether or not the passenger P is a targeted user of the automated gate 40 based on the information regarding the position of the mobile terminal 30 acquired in such a way. Specific examples are as below.

For example, the CPU 302 of the mobile terminal 30 can detect that the passenger P carrying the mobile terminal 30 enters the country of interest based on the position information acquired by the position sensor 314 or the terrestrial magnetism information acquired by the magnetic sensor 316 as described above. The CPU 302 can determine that the timing when entry of the passenger P to the country of interest is detected in such a way is the particular notification timing to notify whether or not he/she is a targeted user of the automated gate 40.

Furthermore, for example, the CPU 302 of the mobile terminal 30 can detect that the passenger P carrying the mobile terminal 30 approaches the automated gate 40 in an airport of the country of interest by using indoor positioning based on terrestrial magnetism information acquired by the magnetic sensor 316. Further, the CPU 302 can detect that the passenger P carrying the mobile terminal 30 approaches the automated gate 40 in an airport in the country of interest by using indoor positioning based on a beacon signal received by the short-range wireless communication unit 310. The beacon signal is a beacon signal using a Bluetooth Low Energy (BLE), for example. Further, the beacon signal is transmitted from a plurality of beacon transmitters installed entirely in the airport. Note that indoor positioning technologies for detecting approach to the automated gate 40 are not limited the above, and various indoor positioning technologies using Wi-Fi positioning or the like may be used.

The CPU 302 of the mobile terminal 30 can determine that the timing when approach of the passenger P to the automated gate 40 is detected as described above is the particular notification timing to notify whether or not the passenger P is a targeted user of the automated gate 40. Note that the degree that the passenger P approaches the automated gate 40 is not particularly limited. For example, when the passenger P enters a position to the degree that the inspection site A or the automated gate 40 is visible from the passenger P, the CPU 302 can determine that the passenger P approaches the automated gate 40 and detect that the passenger P approaches the automated gate 40.

The CPU 302 of the mobile terminal 30 determines that it is a particular notification timing to notify whether or not the passenger P is a targeted user of the automated gate 40 as described above. If it is determined to be the particular notification timing (step S102, YES), the CPU 302 transmits a determination request to the notification server 10 via the mobile communication network NW2 and the network NW1 (step S104). The determination request transmitted here is to request determination as to whether or not the passenger P is a targeted user of the automated gate 40.

The determination request includes personal identification information that uniquely identifies the passenger P who requests determination. The personal identification information is not particularly limited and may be a passport number, for example. Further, the personal identification information may be a combination of two or more of identity information such as a name, a nationality, a date of birth, and the like, for example. The personal identification information may be, for example, information included in ED card information, passport information, or the like input in the support application as described above or may be information input in mobile payment of airport taxes. Further, the personal identification information may be information registered in advance in the support application.

In response to receiving the determination request transmitted from the mobile terminal 30, the CPU 102 of the notification server 10 transmits an information request that requests information associated with the personal identification information on the passenger P to the management server 20 via the network NW1 (step S106). The information requested here is passage history information or preregistered information associated with the personal identification information on the passenger P.

In response to receiving the information request transmitted from the notification server 10, the CPU 202 of the management server 20 extracts requested information from information stored in the storage device 206 (step S108). That is, the CPU 202 extracts passage history information associated with the personal identification information on the passenger P from passage history information registered in the passage history information DB 206a of the storage device 206. Further, the CPU 202 extracts preregistered information associated with the personal identification information on the passenger P from preregistered information registered in the preregistered information DB 206b of the storage device 206.

Next, the CPU 202 transmits response information for the information request to the notification server 10 via the network NW1 (step S110). The response information includes passage history information when the passage history information associated with the personal identification information on the passenger P is extracted and includes preregistered information when preregistered information associated with the personal identification information on the passenger P is extracted. On the other hand, when neither passage history information nor preregistered information associated with the personal identification information on the passenger P is extracted, the response information is information used for responding that neither passage history information nor preregistered information associated with the personal identification information on the passenger P has been extracted.

In response to receiving the response information transmitted from the management server 20, the CPU 102 of the notification server 10 determines whether or not the passenger P is a targeted user of the automated gate 40 based on the response information (step S112).

First, if the response information includes preregistered information associated with the personal identification information on the passenger P, the CPU 102 determines that the passenger P is a targeted user of the automated gate 40 regardless of whether or not the response information includes passage history information (step S112, YES).

Further, if the response information does not include preregistered information but includes passage history information associated with the personal identification information on the passenger P, the CPU 102 determines whether or not the passenger P is a targeted user of the automated gate 40 based on the passage history information associated with the personal identification information on the passenger P. That is, for the passenger P, the CPU 102 calculates the number of times of passages to the country of interest within a predetermined period immediately before the entry to the country of interest based on the passage history information associated with the personal identification information on the passenger P. If the calculated number of times of passages is greater than or equal to the predetermined number of times, the CPU 102 determines that the passenger P is a targeted user of the automated gate 40 (step S112, YES). For example, if the calculated number of times of passages is five or greater within a year immediately before the entry to the country, one or greater within one month or two months immediately before the entry to the country, or the like, the CPU 102 determines that the passenger P is a targeted user of the automated gate 40. On the other hand, if the calculated number of times of passages is less than the predetermined number of times, the CPU 102 determines that the passenger P is not a targeted user of the automated gate 40 (step S112, NO).

Further, if the response information is information responding that neither passage history information nor preregistered information associated with the personal identification information on the passenger P has been extracted, the CPU 102 determines that the passenger P is not a targeted user of the automated gate 40 (step S112, NO).

Next, if the passenger P is determined to be a targeted user of the automated gate 40 (step S112, YES), the CPU 102 generates a notification indicating that the passenger P is a targeted user of the automated gate 40 (step S114). On the other hand, if the passenger P is not determined to be a targeted user of the automated gate 40 (step S112, NO), the CPU 102 generates a notification indicating that the passenger P is not a targeted user of the automated gate 40 (step S116).

Next, the CPU 102 transmits the notification generated in step S114 or step S116 to the mobile terminal 30 via the network NW1 and the mobile communication network NW2 (step S118). Note that the CPU 102 can also transmit an electronic mail including a content of the notification generated in step S114 or step S116 to an electronic mail address of the passenger P in addition to or instead of transmission of the notification. In such a way, the CPU 102 transmits a notification indicating whether or not the passenger P is a targeted user of the automated gate 40 to the mobile terminal 30 at a particular notification timing described above.

Note that the notification indicating whether or not the passenger P is a targeted user of the automated gate 40 may be transmitted to the mobile terminal 30 once at a certain particular notification timing or may be transmitted to the mobile terminal 30 for multiple times at multiple particular notification timings that are different from each other.

In response to receiving the notification transmitted from the notification server 10, the CPU 302 of the mobile terminal 30 displays the received notification on the display 312 (step S120). That is, the CPU 302 displays the notification indicating that the passenger P is a targeted user of the automated gate 40 on the display 312 as illustrated in FIG. 9 or displays the notification indicating that the passenger P is not a targeted user of the automated gate 40 on the display 312 as illustrated in FIG. 10.

Note that the form in which the CPU 302 displays a notification on the display 312 is not particularly limited. For example, the notification may be displayed in a screen of the support application as illustrated in FIG. 9 and FIG. 10, may be displayed with popup display, or may be displayed in a notification region.

The passenger P who has received a notification that the passenger P is a targeted user of the automated gate 40 at the mobile terminal 30 may move to the automated gate 40 in the inspection site A and have an immigration inspection procedure at the automated gate 40. On the other hand, the passenger P who has received a notification that the passenger P is not a targeted user of the automated gate 40 at the mobile terminal 30 may move to the face-to-face inspection booth B in the inspection site A and have an immigration inspection procedure with the examiner E.

As described above, according to the present example embodiment, since the mobile terminal 30 of the passenger P is notified whether or not the passenger P is a targeted user of the automated gate 40 at a particular notification timing, it is possible to smoothly notify that the passenger P is a targeted user of the automated gate 40.

### Second Example Embodiment

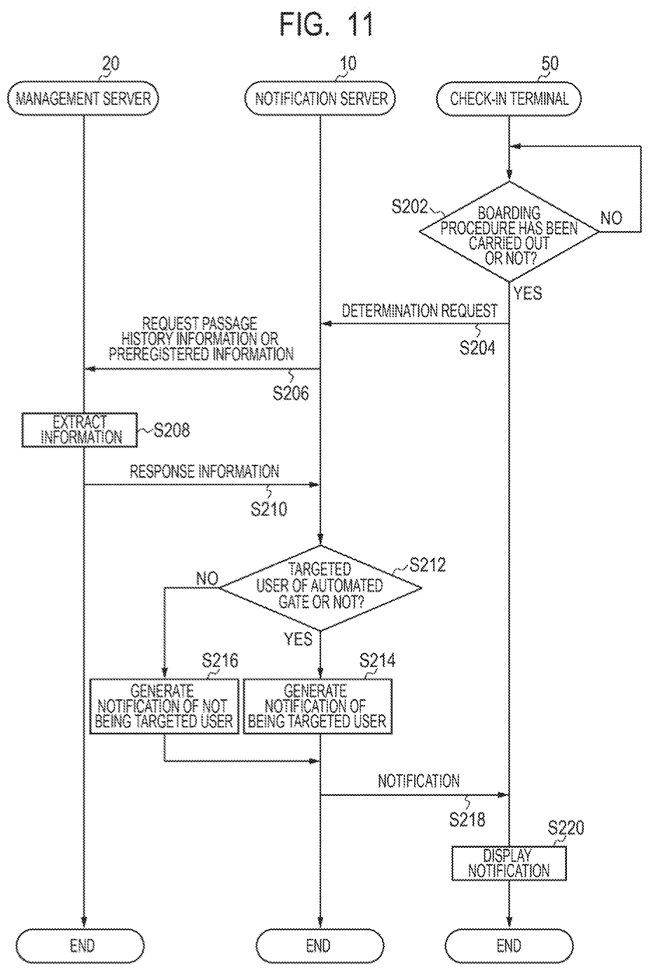

A notification apparatus, a terminal, a notification system, and a notification method according to a second example embodiment of the present invention will be described with reference to FIG. 11. Note that the same components as those of the notification apparatus, the terminal, the notification system, and the notification method according to the first example embodiment described above are labeled with the same references, and the description thereof will be omitted or simplified.

Although the case of notifying the mobile terminal 30 of the passenger P whether or not the passenger P is a targeted user of the automated gate 40 has been described in the above first example embodiment, the example embodiment is not limited thereto. In the present example embodiment, a case of notifying the check-in terminal 50 when the passenger P who makes a passage to the country of interest has carried out a boarding procedure of an airplane bound for the country of interest at the check-in terminal 50 in an airport in a foreign country will be described. Note that the configuration of the notification system 1 according to the present example embodiment is the same as the configuration of the notification system 1 according to the first example embodiment illustrated in FIG. 1 to FIG. 4.

In the present example embodiment, the check-in terminal 50 performs a process regarding a boarding procedure for the passenger P.

Furthermore, the check-in terminal 50 functions as a terminal that receives a notification as to whether or not the passenger P is a targeted user of the automated gate 40 and has a receiving unit that receives the notification and a display unit that displays the notification as with the mobile terminal 30 according to the first example embodiment.

The check-in terminal 50 may be an automatic check-in terminal operated by the passenger P to carry out a boarding procedure or may be a check-in terminal installed in a manned counter and operated by the staff of an airline company.

A notification operation in the notification system 1 according to the present example embodiment will be further described below with reference to FIG. 11. FIG. 11 is a sequence diagram illustrating the operation of the management server 20, the notification server 10, and the check-in terminal 50 in the notification system 1 according to the present example embodiment. When the notification operation in the notification system 1 according to the present example embodiment is performed, a notification method according to the present example embodiment is performed.

First, as illustrated in FIG. 11, the check-in terminal 50 determines whether or not a boarding procedure of the passenger P has been carried out (step S202). In the present example embodiment, the timing when the boarding procedure of the passenger P is carried out is a particular notification timing to notify whether or not the passenger P is a targeted user of the automated gate 40. If it is determined that the boarding procedure has not yet been carried out (step S202, NO), the check-in terminal 50 continuously determines whether or not the boarding procedure has been carried out and stands by for the boarding procedure.

If it is determined that the boarding procedure of the passenger P has been carried out (step S202, YES), the check-in terminal 50 transmits a determination request to the notification server 10 via the network NW1 (step S204). The determination request transmitted in the present example embodiment is to request determination as to whether or not the passenger P who carried out a boarding procedure is a targeted user of the automated gate 40.

Also in the present example embodiment, in the same manner as in the first example embodiment, the determination request includes personal identification information that uniquely identifies the passenger P who requests determination. For example, the personal identification information may be a passport number or may be a combination of two or more of identity information as with in the first example embodiment. However, the personal identification information in the present example embodiment is information input to the check-in terminal 50 in a boarding procedure.

In response to receiving the determination request transmitted from the mobile terminal 30, the CPU 102 of the notification server 10 transmits an information request that requests information associated with the personal identification information on the passenger P to the management server 20 via the network NW1 (step S206). Step S206 of the present example embodiment is the same as step S106 of the first example embodiment.

In response to receiving the information request transmitted from the notification server 10, the CPU 202 of the management server 20 extracts requested information from information stored in the storage device 206 (step S208). Step S208 of the present example embodiment is the same as step S108 of the first example embodiment.

Next, the CPU 202 transmits response information for the information request to the notification server 10 via the network NW1 (step S210). Step S210 of the present example embodiment is the same as step S110 of the first example embodiment.

In response to receiving the response information transmitted from the management server 20, the CPU 102 of the notification server 10 determines whether or not the passenger P is a targeted user of the automated gate 40 based on the response information (step S212). Step S212 of the present example embodiment is the same as step S112 of the first example embodiment.

Next, if it is determined that the passenger P is a targeted user of the automated gate 40 (step S212, YES), the CPU 102 generates a notification indicating that the passenger P is a targeted user of the automated gate 40 (step S214). On the other hand, if it is determined that the passenger P is not a targeted user of the automated gate 40 (step S212, NO), the CPU 102 generates a notification indicating that the passenger P is not a targeted user of the automated gate 40 (step S216). Steps S214 and S216 of the present example embodiment are the same as steps S114 and S116 of the first example embodiment, respectively.

Next, the CPU 102 transmits the notification generated in step S214 or step S216 to the check-in terminal 50 via the network NW1 (step S218). Note that the CPU 102 can also transmit an electronic mail including the content of the notification generated in step S114 or step S116 to an electronic mail address of the passenger P in addition to or instead of transmission of the notification in the same manner as in the first example embodiment.

In response to receiving the notification transmitted from the notification server 10, the check-in terminal 50 displays the received notification on the display (step S220). That is, the check-in terminal 50 displays the notification indicating that the passenger P is a targeted user of the automated gate 40 on the display 312 or displays the notification indicating that the passenger P is not a targeted user of the automated gate 40 on the display 312.

Note that the check-in terminal 50 can write the content of the notification on a boarding ticket issued in a boarding procedure in addition to or instead of display of the notification on the display thereof.

The passenger P who has carried out the boarding procedure can recognize whether or not he/she is a targeted user of the automated gate 40 in accordance with the notification displayed on the check-in terminal 50 or the notification written in the boarding ticket. When the check-in terminal 50 is an automatic check-in terminal, the passenger P can confirm the notification displayed on the check-in terminal 50 by himself/herself. On the other hand, when the check-in terminal 50 is a check-in terminal installed in a manned counter, the staff of an airline company can confirm the content of the notification displayed on the check-in terminal 50 and convey the content of the notification to the passenger P.

As described in the present example embodiment, it is also possible to notify the check-in terminal 50 whether or not the passenger P is a targeted user of the automated gate 40 at the timing when a boarding procedure is carried out at the check-in terminal 50. According to the present example embodiment, since notification is performed at a timing when a boarding procedure is carried out, it is possible to smoothly notify that the passenger P is a targeted user of the automated gate 40.

Note that it is also possible to both notify the check-in terminal 50 as with the present example embodiment and notify the mobile terminal 30 as with the first example embodiment and it is also possible to notify either one of the check-in terminal 50 and the mobile terminal 30.

Note that, although the case of notifying the check-in terminal 50 has been described above as an example, a terminal that is notified is not limited thereto. For example, a digital signage terminal having a face recognition function may be notified. In such a case, a digital signage terminal is installed within a premise or the like of an airport of the country of interest, for example. The passenger P who has to go to the inspection site A may pass in front of the digital signage terminal. Once the passenger P passes in front of the digital signage terminal, the digital signage terminal uses a camera or the like thereof to acquire a face image of the passenger P as biometric information on the passenger P and transmits the acquired biometric information on the passenger P to the notification server 10 via the network NW1. The notification server 10 matches the transmitted biometric information on the passenger P with biometric information included in passage history information in the passage history information DB 206a or preregistered information in the preregistered information DB 206b of the management server 20 and identifies the passenger P who passes in front of the digital signage terminal. The notification server 10 determines whether or not the identified passenger P is a targeted user of the automated gate 40 and generates a notification indicating a determination result in the same manner as in the case described above. Next, the notification server 10 transmits the generated notification to the digital signage terminal via the network NW1. In response to receiving the notification from the notification server 10, the digital signage terminal displays, on the display thereof, the notification indicating that the passenger P is a targeted user of the automated gate 40 or the notification indicating that the passenger P is not a targeted user of the automated gate 40 in accordance with the notification content. The passenger P passing in front of the digital signage terminal can recognize whether or not he/she is a targeted user of the automated gate 40 from the notification displayed on the display of the digital signage terminal.

### Other Example Embodiments

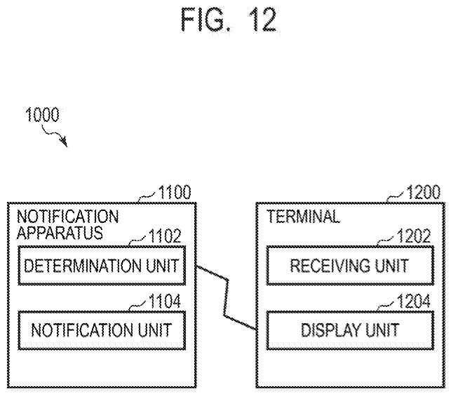

The information processing apparatus described in the above example embodiments can be configured as illustrated in FIG. 12 according to yet another example embodiment. FIG. 12 is a block diagram illustrating a configuration of a notification system according to another example embodiment.

As illustrated in FIG. 12, a notification system 1000 according to the other example embodiment includes a notification apparatus 1100 and a terminal 1200 configured to communicate with the notification apparatus 1100.

The notification apparatus 1100 includes a determination unit 1102 that determines whether or not a passenger is a targeted user of an automated gate and a notification unit 1104 that transmits, to the terminal 1200, a notification indicating whether or not the passenger is a targeted user of the automated gate.

The terminal 1200 is a mobile terminal carried by the passenger, a check-in terminal at which the passenger performs a boarding procedure, or a digital signage terminal. The terminal 1200 includes a receiving unit 1202 that receives the notification and a display unit 1204 that displays the notification.

According to the other example embodiment, the terminal 1200, which is a mobile terminal carried by the passenger, a check-in terminal at which the passenger performs a boarding procedure, or a digital signage terminal, is notified whether or not the passenger is a targeted user of the automated gate. Thus, according to the other example embodiment, it is possible to smoothly notify that the passenger is a targeted user of the automated gate.

### Modified Example Embodiments

The present invention is not limited to the example embodiments described above, and various modifications are possible.

For example, although the case where the notification server 10 and the management server 20 are separate servers has been described as an example in the above example embodiments, the present invention is not limited thereto. It is also possible to configure a single server to function as the notification server 10 and the management server 20. Further, it is also possible to configure an individual terminal such as the mobile terminal 30, the check-in terminal 50, a digital signage terminal, or the like to function as the notification server 10.

Further, although the case of notifying whether or not the passenger P is a targeted user of the automated gate 40 in the inspection site A in which immigration inspection is performed has been described as an example in the above example embodiments, the present invention is not limited thereto. The notification system according to the present invention can be applied to any case where biometric information is acquired and used. The notification system according to the present invention can be widely applied to a case of notifying whether or not a person is a targeted user of an automated gate that automatically examines whether to permit or reject entry or exit at an entrance of a facility, a site, or the like, for example.

Further, the scope of each of the example embodiments includes a processing method that stores, in a storage medium, a program that causes the configuration of each of the example embodiments to operate so as to implement the function of each of the example embodiments described above, reads the program stored in the storage medium as a code, and executes the program in a computer. That is, the scope of each of the example embodiments also includes a computer readable storage medium. Further, each of the example embodiments includes not only the storage medium in which the computer program described above is stored but also the computer program itself.

As the storage medium, for example, a floppy (registered trademark) disk, a hard disk, an optical disk, a magneto-optical disk, a compact disk-read only memory (CD-ROM), a magnetic tape, a nonvolatile memory card, or a ROM can be used. Further, the scope of each of the example embodiments includes an example that operates on operating system (OS) to perform a process in cooperation with another software or a function of an add-in board without being limited to an example that performs a process by an individual program stored in the storage medium.

The whole or part of the example embodiments disclosed above can be described as, but not limited to, the following supplementary notes.

(Supplementary Note 1)

A notification apparatus comprising:

a determination unit that determines whether or not a passenger is a targeted user of an automated gate; and

a notification unit that transmits, to a mobile terminal carried by the passenger, a notification indicating whether or not the passenger is a targeted user of the automated gate.

(Supplementary Note 2)

The notification apparatus according to supplementary note 1, wherein the determination unit determines whether or not the passenger is a targeted user of the automated gate based on preregistered information on the passenger.

(Supplementary Note 3)

The notification apparatus according to supplementary note 1, wherein the determination unit determines whether or not the passenger is a targeted user of the automated gate based on a passage history of the passenger.

(Supplementary Note 4)

The notification apparatus according to supplementary note 1, wherein the determination unit determines whether or not the passenger is a targeted user of the automated gate based on the number of times of passages within a predetermined period that is a passage history of the passenger.

(Supplementary Note 5)

The notification apparatus according to supplementary note 1, wherein if the number of times of passages within a predetermined period that is a passage history of the passenger exceeds a predetermined value, the determination unit determines that the passenger is a targeted user of the automated gate.

(Supplementary Note 6)

The notification apparatus according to any one of supplementary notes 1 to 5, wherein the notification unit transmits the notification to the mobile terminal at a timing when the mobile terminal is operated in association with entry to a country or departure from a country.

(Supplementary Note 7)

The notification apparatus according to supplementary note 6, wherein the notification unit transmits the notification to the mobile terminal at a timing when embarkation/disembarkation card information or passport information is input to the mobile terminal by the passenger.

(Supplementary Note 8)

The notification apparatus according to supplementary note 6 or 7, wherein the notification unit transmits the notification to the mobile terminal at a timing when mobile payment of a tax required to be paid in association with entry to a country or departure from a country is performed by the mobile terminal.

(Supplementary Note 9)

The notification apparatus according to any one of supplementary notes 1 to 8, wherein the notification unit transmits the notification to the mobile terminal at a timing based on information on a position of the mobile terminal.

(Supplementary Note 10)

The notification apparatus according to any one of supplementary notes 1 to 9, wherein the notification unit transmits the notification to the mobile terminal at a timing when the passenger carrying the mobile terminal approaches the automated gate.

(Supplementary Note 11)

A notification apparatus comprising:

a determination unit that determines whether or not a passenger is a targeted user of an automated gate; and

a notification unit that transmits, to a check-in terminal at which the passenger carries out a boarding procedure, a notification indicating whether or not the passenger is a targeted user of the automated gate.

(Supplementary Note 12)

The notification apparatus according to supplementary note 11, wherein the notification unit transmits the notification to the check-in terminal at a timing when the boarding procedure of the passenger is carried out at the check-in terminal.

(Supplementary Note 13)

A notification apparatus comprising:

a determination unit that determines whether or not a passenger is a targeted user of an automated gate; and

a notification unit that transmits, to a digital signage terminal, a notification indicating whether or not the passenger is a targeted user of the automated gate.

(Supplementary Note 14)

A terminal configured to communicate with a notification apparatus,

wherein the notification apparatus includes

a determination unit that determines whether or not a passenger is a targeted user of an automated gate, and

a notification unit that transmits, to the terminal, a notification indicating whether or not the passenger is a targeted user of the automated gate, and

wherein the terminal is a mobile terminal carried by the passenger and includes

a receiving unit that receives the notification, and

a display unit that displays the notification.

(Supplementary Note 15)

A notification system comprising a notification apparatus and a terminal configured to communicate with the notification apparatus,

wherein the notification apparatus includes

a determination unit that determines whether or not a passenger is a targeted user of an automated gate, and

a notification unit that transmits, to the terminal, a notification indicating whether or not the passenger is a targeted user of the automated gate, and

wherein the terminal is a mobile terminal carried by the passenger and includes

a receiving unit that receives the notification, and

a display unit that displays the notification.

(Supplementary Note 16)

A notification method comprising:

determining whether or not a passenger is a targeted user of an automated gate; and

transmitting, to a mobile terminal carried by the passenger, a notification indicating whether or not the passenger is a targeted user of the automated gate.

(Supplementary note 17)

A storage medium storing a program that causes a computer to perform:

determining whether or not a passenger is a targeted user of an automated gate; and

transmitting, to a mobile terminal carried by the passenger, a notification indicating whether or not the passenger is a targeted user of the automated gate.

As described above, while the present invention has been described with reference to the example embodiments, the present invention is not limited to these example embodiments described above. Various modifications that can be understood by those skilled in the art can be made to the configuration and details of the present invention within the scope of the present invention.

This application is based upon and claims the benefit of priority from Japanese Patent Application No. 2018-097937, filed on May 22, 2018, the disclosure of which is incorporated herein in its entirety by reference.

### REFERENCE SIGNS LIST

1 notification system
10 notification server
20 management server
30 mobile terminal
40 automated gate
50 check-in terminal
NW1 network
NW2 mobile communication network

1. A notification apparatus comprising:
a memory configured to store instructions; and
a processor configured to execute the instructions to:
determine whether a passenger is a targeted user of an automated gate; and
transmit, to a mobile terminal carried by the passenger, a notification indicating whether the passenger is a targeted user of the automated gate.

2. The notification apparatus according to claim 1, wherein the processor is configured to execute the instructions to:
determine whether the passenger is a targeted user of the automated gate based on preregistered information on the passenger.

3. The notification apparatus according to claim 1, wherein the processor is configured to execute the instructions to:
determine whether the passenger is a targeted user of the automated gate based on a passage history of the passenger.

4. The notification apparatus according to claim 1, wherein the processor is configured to execute the instructions to:
determine whether the passenger is a targeted user of the automated gate based on the number of times of passages within a predetermined period that is a passage history of the passenger.

5. The notification apparatus according to claim 1, wherein if the number of times of passages within a predetermined period that is a passage history of the passenger exceeds a predetermined value, the processor is configured to execute the instructions to:
determine that the passenger is a targeted user of the automated gate.

6. The notification apparatus according to claim 1, wherein the processor is configured to execute the instructions to:
transmit the notification to the mobile terminal at a timing when the mobile terminal is operated in association with entry to a country or departure from a country.

7. The notification apparatus according to claim 6, wherein the processor is configured to execute the instructions to:
transmit the notification to the mobile terminal at a timing when embarkation/disembarkation card information or passport information is input to the mobile terminal by the passenger.

8. The notification apparatus according to claim 6, wherein the processor is configured to execute the instructions to:
transmit the notification to the mobile terminal at a timing when mobile payment of a tax required to be paid in association with entry to a country or departure from a country is performed by the mobile terminal.

9. The notification apparatus according to claim 1, wherein the processor is configured to execute the instructions to:
transmit the notification to the mobile terminal at a timing based on information on a position of the mobile terminal.

10. The notification apparatus according to claim 1, wherein the processor is configured to execute the instructions to:
transmit the notification to the mobile terminal at a timing when the passenger carrying the mobile terminal approaches the automated gate.

11. A notification apparatus comprising:
a memory configured to store instructions; and
a processor configured to execute the instructions to:
determine whether a passenger is a targeted user of an automated gate; and
transmit, to a check-in terminal at which the passenger carries out a boarding procedure, a notification indicating whether the passenger is a targeted user of the automated gate.

12. The notification apparatus according to claim 11, wherein the processor is configured to execute the instructions to:
transmit the notification to the check-in terminal at a timing when the boarding procedure of the passenger is carried out at the check-in terminal.

13. A notification apparatus comprising:
a memory configured to store instructions; and
a processor configured to execute the instructions to:
receive a first facial image of a user who is present in front of a display terminal;
compare the first facial image with a second facial image, among a plurality of second facial images registered;
determine whether the user is a targeted user of an automated gate stage based on the compare operation; and
transmit, to a digital signage terminal, a notification indicating whether the user is a targeted user of the automated gate.

14. A terminal configured to communicate with a notification apparatus, the terminal comprising
a memory configured to store instructions; and
a processor configured to execute the instructions to:
receive a notification sent from the notification apparatus indicating that the passenger is a targeted user of the automated gate, and
display information, based on the received notification, indicating that the passenger is a targeted user of the automated gate,
wherein the terminal is a mobile terminal carried by the.

15. A notification system comprising a notification apparatus and a terminal configured to communicate with the notification apparatus,
wherein the notification apparatus comprises:
a first memory configured to store instructions; and
a first processor configured to execute the instructions to:
determine whether a passenger is a targeted user of an automated gate; and
transmit, to the terminal, a notification indicating whether the passenger is a targeted user of the automated gate, and
wherein the terminal is a mobile terminal carried by the passenger and comprises:
a second memory configured to store instructions; and
a second processor configured to execute the instructions to:
receive the notification; and
display the notification.

16. A notification method comprising:
determining whether a passenger is a targeted user of an automated gate; and
transmitting, to a mobile terminal carried by the passenger, a notification indicating whether the passenger is a targeted user of the automated gate.

17. A non-transitory computer readable storage medium storing a program that causes a computer to perform operations comprising:
determining whether a passenger is a targeted user of an automated gate; and
transmitting, to a mobile terminal carried by the passenger, a notification indicating whether the passenger is a targeted user of the automated gate.

18. The notification apparatus according to claim 1, wherein the targeted user is a person permitted to use the automated gate.
